(19) United States
(12) Patent Application Publication
(10) Pub. No.: US 2025/0218709 A1
(43) Pub. Date: Jul. 3, 2025

(54) SWITCH UNIT, KEY SWITCH ASSEMBLY, AND KEYBOARD

(71) Applicant: FCL COMPONENTS LIMITED, Tokyo (JP)

(72) Inventors: Akihiko ARIKAWA, Tokyo (JP); Takeshi NISHINO, Tokyo (JP)

(73) Assignee: FCL COMPONENTS LIMITED, Tokyo (JP)

(21) Appl. No.: 18/931,798

(22) Filed: Oct. 30, 2024

(30) Foreign Application Priority Data
Dec. 27, 2023 (JP) 2023-221570
Aug. 2, 2024 (JP) 2024-127878

(51) Int. Cl. H01H 13/7057; H01H 13/14

(52) U.S. Cl. CPC H01H 13/7057; H01H 13/14

(57) ABSTRACT

A switch unit includes a sliding member which is slidable by pressing operation of the operating member, and a supporting member that supports the sliding member. An electrical contact is opened and closed in accordance with sliding movement of the sliding member. The sliding member includes a pedestal, a first projection provided on a pressing operation side and capable of attaching the operating member, and a column provided on a side opposite to the pressing operation side from the pedestal along the sliding direction. The supporting member includes a plate and a first guide provided from the plate to the pressing operation side along the sliding direction. The pedestal has a first through hole through which the first guide passes, and the first guide has a second through hole into which the column is inserted.

### CROSS-REFERENCE TO RELATED APPLICATION

This application is based upon and claims the benefit of priority of the prior Japanese Patent Application No. 2023-221570 filed on Dec. 27, 2023, and the prior Japanese Patent Application No. 2024-127878 filed on Aug. 2, 2024, the entire contents of which are incorporated herein by reference.

### FIELD

A certain aspect of the embodiments is related to a switch unit, a key switch assembly, and a keyboard.

### BACKGROUND

There has been known a key switch assembly that includes a key top which is pressed downward, a slider which is press-fitted into the lower surface of the key top, a rubber which is elastically buckled and deformed by the pressing operation of the key top and gives a repulsive force corresponding to the elastic buckling deformation to the slider, and a contact pressing member which is provided so as to be relatively movable with respect to the slider and gives a pressing force independent of the operating force of the key top to a membrane switch. Note that the technique related to the present disclosure is disclosed in Patent Document 1 (Japanese Laid-Open Patent Publication No. 2011-249282).

### SUMMARY

According to a first aspect of the present disclosure, there is provided a switch unit including: a sliding member to which an operating member is attachable and which is slidable by pressing operation of the operating member; and a supporting member that supports the sliding member, wherein an electrical contact is opened and closed in accordance with sliding movement of the sliding member, the sliding member includes a pedestal, a first projection provided on a pressing operation side from the pedestal along a sliding direction of the sliding member and capable of attaching the operating member, and a column provided on a side opposite to the pressing operation side from the pedestal along the sliding direction, the supporting member includes a plate and a first guide provided from the plate to the pressing operation side along the sliding direction, the pedestal has a first through hole through which the first guide passes, and the first guide has a second through hole into which the column is inserted.

According to a second aspect of the present disclosure, there is provided a switch unit including: a sliding member to which an operating member is attachable and which is slidable by pressing operation of the operating member; a first elastic member that is attached to the sliding member and elastically deforms in response to the pressing operation of the operating member; a second elastic member that is attached to the sliding member and opens and closes an electrical contact in response to sliding of the sliding member; and a supporting member including: a plate having a first surface and a second surface opposite to the first surface; a first guide that stands on the first surface of the plate and guides the sliding member; a second guide that stands on the first surface of the plate, guides the first elastic member, and is provided outside the first guide when the plate is viewed from above; and a leg portion that stands on the second surface of the plate.

### BRIEF DESCRIPTION OF DRAWINGS

FIG. 1A is a perspective view illustrating an overall configuration of a key switch assembly according to a first embodiment, and FIG. 1B is an exploded perspective view of the key switch assembly.

FIGS. 2A and 2B are cross-sectional views taken along a line A-A of the key switch assembly illustrated in FIG. 1A.

FIGS. 3A and 3B are perspective views of a slider, and FIG. 3C is a cross-sectional view of the slider of FIG. 3A taken along a line B-B.

FIGS. 4A and 4B are perspective views of a housing, and FIG. 4C is a side view of the housing viewed from a Y direction.

FIG. 5 is a cross-sectional view of the key switch assembly when LEDs are disposed in through holes.

FIG. 6 is a diagram illustrating a depressing characteristic of the key switch assembly according to the first embodiment.

FIG. 7 is a perspective view of a keyboard according to the first embodiment.

FIG. 8A is an exploded perspective view illustrating each of components of a switch unit included in a key switch assembly according to a second embodiment, and

FIG. 8B is a perspective view of an integrated switch unit.

FIG. 9A is a plan view illustrating the front side of the key top, FIG. 9B is a cross-sectional view taken along a line A-A of FIG. 9A, FIG. 9C is a cross-sectional view taken along a line B-B of FIG. 9A, and FIG. 9D is a plan view illustrating the back side of the key top.

FIG. 10A is a plan view of the slider viewed from above, FIG. 10B is a cross-sectional view taken along a line A-A of FIG. 10A, FIG. 10C is a cross-sectional view taken along a line B-B of FIG. 10A, and FIG. 10D is a perspective view of the slider.

FIG. 11A is a plan view of the housing as viewed from above, FIG. 11B is a cross-sectional view taken along a line A-A of FIG. 11A, FIG. 11C is a cross-sectional view taken along a line B-B of FIG. 11A, and FIG. 11D is a perspective view of the housing.

FIG. 12A is a plan view of a key switch assembly according to the second embodiment as viewed from above, FIG. 12B is a cross-sectional view taken along a line A-A in FIG. 12A, and FIG. 12C is a cross-sectional view taken along a line B-B in FIG. 12A.

FIG. 13 is a diagram illustrating an example in which the plurality of key switch assemblies are arranged.

### DESCRIPTION OF EMBODIMENTS

There are many keyboards with interchangeable keytops in the market, and there are also interchangeable keytops. A recess for detachably attaching, for example, a cross-shaped projection provided on a key switch side is formed in the back surface of a replacement key top.

In the key switch assembly of Patent Document 1, since no projection for detachably attaching the key top is formed on the upper surface of the slider and the slider is press-fitted to the lower surface of the key top, the replacement key top cannot be attached.

Further, if a cross-shaped projection is provided on the upper surface of the slider of Patent Document 1, the total height of the key switch assembly becomes high, and in a keyboard in which a plurality of key switch assemblies are arranged, burdens may be applied to the wrists.

Therefore, there is a demand for a switch unit, a key switch assembly, and a keyboard in which the operating member is replaceable and which can provide a good feeling to a user without significantly changing the total height. Further, there is a demand for a switch unit, a key switch assembly, and a keyboard which can be mounted on a member to be mounted at one time without disassembling the switch unit.

According to one aspect of the present disclosure, an operating member is replaceable and can provide a good feel to the user without significantly changing the overall height. According to another aspect of the present disclosure, the switch unit can be collectively mounted on the member to be mounted without being disassembled.

Hereinafter, a description will be given of the embodiment of the present disclosure with reference to the drawings.

### First Embodiment

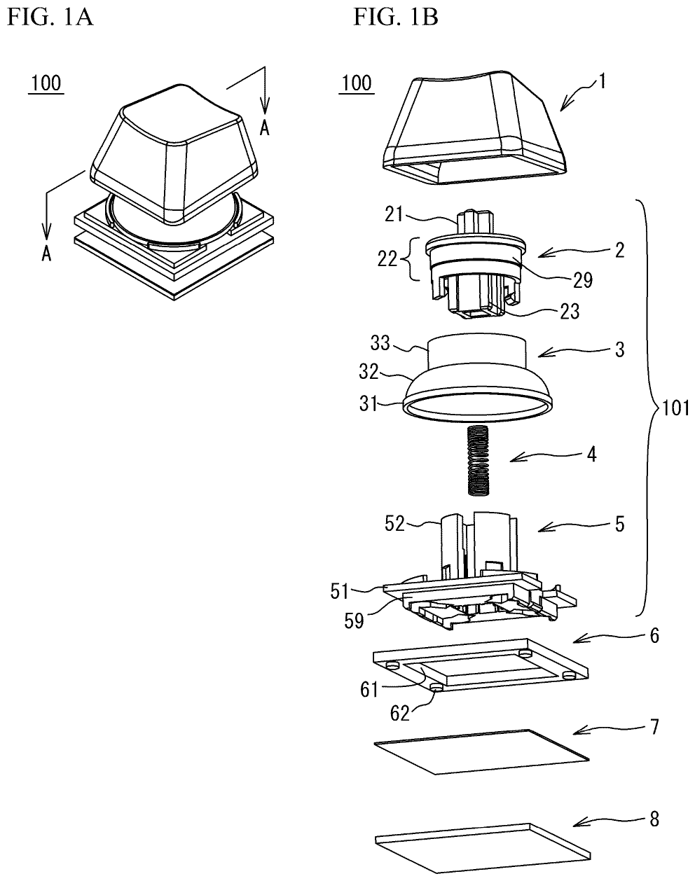

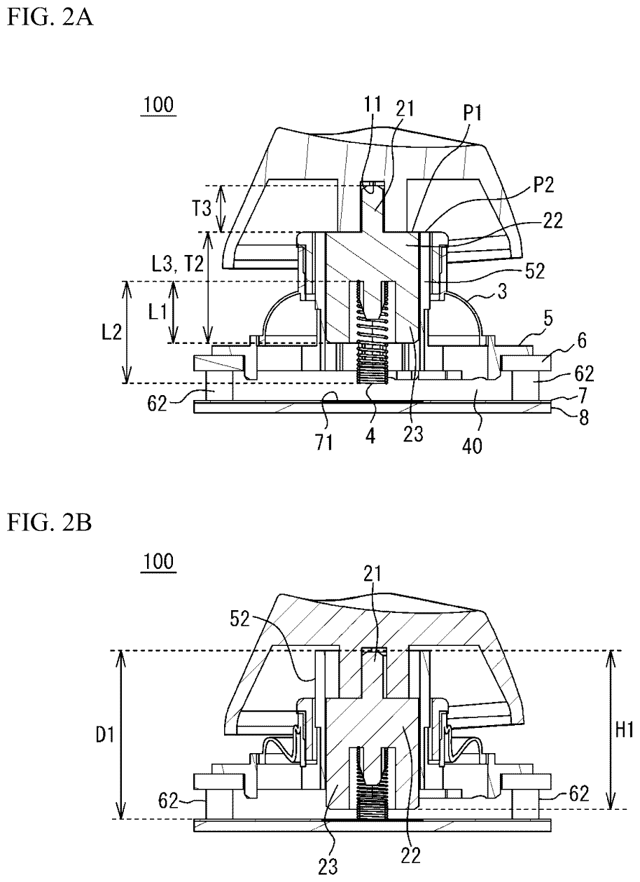

FIG. 1A is a perspective view illustrating the overall configuration of a key switch assembly 100 according to the first embodiment, and FIG. 1B is an exploded perspective view of the key switch assembly 100. FIGS. 2A and 2B are cross-sectional views taken along a line A-A of the key switch assembly 100 illustrated in FIG. 1A, FIG. 2A illustrates a state where a key top is not pressed, and FIG. 2B illustrates a state where the key top is pressed.

In FIG. 1B, a switch unit 101 includes a slider 2 (a sliding member) to which a key top 1 is attached and which slides in a vertical direction, a dome rubber 3 (a first elastic member) which is elastically buckled and deformed by a pressing operation of the key top 1 and gives a repulsive force corresponding to elastic buckling deformation to the slider 2, a spring 4 (a second elastic member) which is attached to the slider 2 and presses down an electrical contact such as a membrane switch 7 or a mechanical switch (not illustrated), and a housing 5 (a supporting member) to which the slider 2 is attached and which supports the sliding of the slider 2 in the vertical direction. A key switch assembly 100 includes the switch unit 101, the key top 1, a switch panel 6 (a member to be mounted) which is a positioning member for determining the position of the housing 5, the membrane switch 7 which is arranged under the housing 5 and the switch panel 6 and is provided with electrical contacts, and a support panel 8 which is arranged under the membrane switch 7 and fixes the switch panel 6.

The key top 1 is formed by integral molding using a resin as a constituent material. A recess 11 to which a cross-shaped projection 21 of the slider 2 is attached is formed in the back surface of the key top 1 (see FIG. 2A).

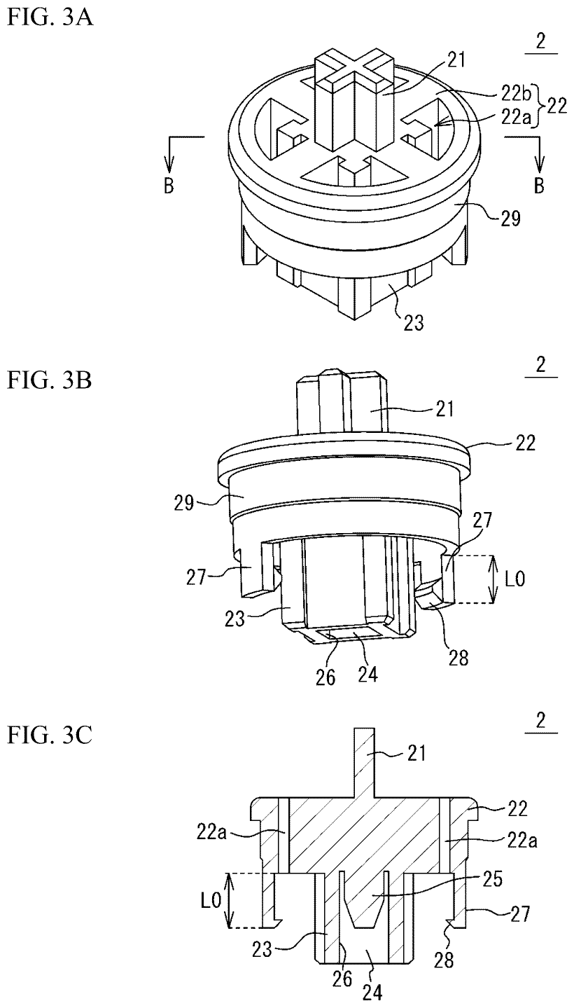

FIGS. 3A and 3B are perspective views of the slider 2, and FIG. 3C is a cross-sectional view of the slider 2 illustrated in FIG. 3A taken along a line B-B.

The slider 2 includes the cross-shaped projection 21 (first projection), a cylindrical pedestal 22, and a rectangular prism-shaped column 23. The projection 21, the pedestal 22, and the column 23 are integrally formed on the same axis along the sliding direction by the pressing operation. The projection 21 is provided on the pedestal 22 on a pressing operation side, and the column 23 is provided inside the pedestal 22 so as to extend on the opposite side of the pressing operation. The upper end of the column 23 is substantially the same as the upper end of the pedestal 22, and a lower portion of the column 23 is exposed from the pedestal 22.

The pedestal 22 has a cylindrical side surface provided with an outer peripheral surface 29 into which the dome rubber 3 is press-fitted, and includes a plurality of couplers 22b as beams for coupling the column 23 and the side surface. Through holes 22a (a first through hole) for passing a guide 52 of the housing 5 described later are provided in regions surrounded by the plurality of couplers 22b and the side surface. The coupler 22b transmits the pressing force from the key top 1 transmitted to the projection 21 to the dome rubber 3.

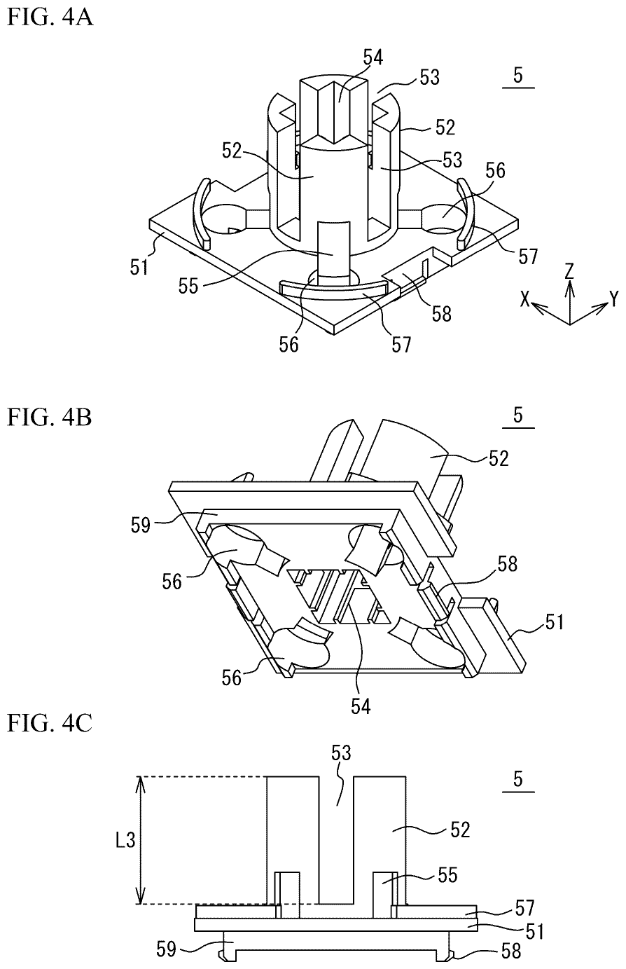

As illustrated in FIG. 3B, extension portions 27 extending vertically downward are formed on a part of the outer periphery of the lower surface of the pedestal 22, and a projection 28 (second projection) projecting radially inward is formed on a lower portion of each of the extension portions 27. The projection 28 engages with a groove 55 formed in the guide 52, which will be described later, so that the slider 2 does not rotate with respect to the housing 5 and the slider 2 does not come out of the groove 55 (see FIG. 4) of the housing 5. This can prevent the key switch assembly 100 from rattling due to the rotation of the slider 2.

A length L0 of the extension portion 27 in the vertical direction (see FIG. 3 b) is set such that, when the key top 1 is not pressed, the position of the upper surface of the pedestal 22 or the coupler 22b is substantially the same as the position of the upper end of the guide 52 in a state where the projection 28 is engaged with the groove 55 of the housing 5. Here, the term “substantially the same” means that the deviation due to the manufacturing error in the positions of the upper surface of the pedestal 22 or the coupler 22b and the upper end of the guide 52 is determined to be the same.

For example, when the key top 1 is not pressed, if a position P1 (see FIG. 2A) of the upper surface of the pedestal 22 or the coupler 22b is higher than a position P2 of the upper end of the guide 52 in a state where the projection 28 is engaged with the groove 55 of the housing 5, a distance between the column 23 and the guide 52 in the vertical direction becomes short, and therefore, rattling may be easily generated. On the other hand, when the key top 1 is not pressed, if the position P1 of the upper surface of the pedestal 22 or the coupler 22b is lower than the position P2 of the upper end of the guide 52 in the state where the projection 28 is engaged with the groove 55 of the housing 5, a distance from the upper end of the guide 52 to the key top 1 becomes short, and therefore, a sufficient key stroke cannot be secured.

Therefore, in the first embodiment, the length L0 of the extension portion 27 in the vertical direction is set such that, when the key top 1 is not pressed, the position P1 of the upper surface of the pedestal 22 or the coupler 22b is substantially the same as the position P2 of the upper end of the guide 52 in a state where the projection 28 is engaged with the groove 55 of the housing 5. Therefore, the rattling can be suppressed while ensuring the key stroke.

The column 23 is inserted into a through hole 54 (see FIG. 4A) of the guide 52 described later, and guides the sliding movement of the slider 2 in the vertical direction together with the through hole 54. Since each of the column 23 and the through hole 54 has a substantially rectangular cross section, the rattling in the rotation direction can be suppressed.

As illustrated in FIG. 3C, the column 23 has an opening 24 formed in a lower portion thereof, and a projection 25 for fixing the spring 4 is formed in the column 23. A part of the spring 4 is inserted between an inner surface 26 of the column 23 and the projection 25 and fixed thereto.

When the key top 1 is not pressed, a part of the spring 4 is disposed below the lower end of the column 23. In other words, when the key top 1 is not pressed, a length L2 of the spring 4 in the vertical direction is longer than a length LI of the opening 24 in the vertical direction (see FIG. 2A). This is because the spring 4 presses the electrical contact when the key top 1 is pressed.

As illustrated in FIG. 2B, a distance D1 from the upper end of the guide 52 to the contact of the membrane switch 7 is larger than a thickness H1 of the slider 2 (that is, the projection 21 and the column 23) in the vertical direction. If the distance D1 from the upper end of the guide 52 to the contact of the membrane switch 7 is smaller than the thickness H1 of the slider 2 in the vertical direction, a distance by which the column 23 and the guide 52 overlap in the vertical direction becomes shorter when the key top 1 is not pressed, and therefore the rattling is likely to occur. Therefore, in the first embodiment, the distance D1 is set larger than the thickness H1.

Referring back to FIG. 1B, the dome rubber 3 is a dome-shaped member integrally molded from a rubber material, and has a ring-shaped base portion 31, a dome portion 32 rising in a dome-like manner from the base portion 31, and a cylindrical portion 33 extending upward from the top of the dome portion 32. The cylindrical portion 33 is press-fitted into the outer peripheral surface 29 of the pedestal 22 of the slider 2 from below, and is mounted on the outer peripheral surface 29. The pedestal 22 of the slider 2 is integrally moved with the cylindrical portion 33.

The slider 2 and the housing 5 are formed of different materials that have less friction when they are in contact with each other. For example, the slider 2 is made of POM resin (polyacetal resin), and the housing 5 is made of ABS resin (thermoplastic resin produced by polymerizing three monomers such as acrylonitrile, butadiene, and styrene). This is because if the slider 2 and the housing 5 are made of the same material, the slider 2 bites into the guide 52 during sliding, and a stack in which the key top 1 does not move occurs. For this reason, the slider 2 and the housing 5 are made of different materials that have less friction when they are in contact with each other. The material of the slider 2 and the housing 5 is not limited to the resins. The slider 2 and the housing 5 may be processed to have a small friction coefficient at the contact portion thereof so that the friction is reduced at the time of contact.

FIGS. 4A and 4B are perspective views of the housing 5, and FIG. 4C is a side view of the housing 5 viewed from the Y direction.

The housing 5 is a member for supporting the slider 2 and the dome rubber 3, and has a square plate 51 constituting a base substrate and the guide 52 (a first guide) standing upward from the center of the plate 51. The through hole 54 (a second through hole) having a substantially rectangular cross section for inserting the column 23 of the slider 2 is opened in the center of the guide 52. The guide 52 is provided with slits 53 so that the coupler 22b of the slider 2 does not interfere with the guide 52 when the slider 2 slides.

As illustrated in FIG. 2A, a length L3 of the slit 53 in the vertical direction is substantially equal to a thickness T2 of the column 23 of the slider 2 in the vertical direction, and is larger than the thickness T3 of the projection 21 of the slider 2 in the vertical direction. Here, the term “substantially the same” means that the deviation due to the manufacturing error is determined to be the same. In this case, since a distance by which the column 23 and the guide 52 overlap can be sufficiently secured in the vertical direction, the rattling can be suppressed.

As illustrated in FIG. 2B, when the key top 1 is pressed and positioned at the lowermost position, the upper end of the slider 2 (i.e., the upper end of the projection 21) is at substantially the same height as or lower than the upper end of the guide 52. In this case, since the projection 21 enters the through hole 54 during the sliding of the slider 2, the projection 21 for mounting the key top I can be provided without greatly changing the total height of the key switch assembly 100 while ensuring the key stroke.

Referring back to FIG. 4A, the groove 55, which is engaged with the projection 28 of the slider 2 and extends in the vertical direction, is formed in the lower portion of the guide 52. For example, when the key top 1 is pressed, the projection 28 of the slider 2 descends in the groove 55, and when the key top 1 is completely pressed, the projection 28 of the slider 2 ascends in the groove 55.

Since the grooves 55 are provided in four directions, the projections 28 of the slider 2 can be inserted into the grooves 55 even when the slider 2 is rotated by 90 degrees. Therefore, the degree of freedom in assembling the key switch assembly 100 is increased, and the workability can be improved. The grooves 55 may be through holes, or the through holes may be formed in parts of the grooves 55. Thus, light of LEDs 70 described later passes through a gap between the slider 2 and the guide 52 through the through holes, and can illuminate the key top 1.

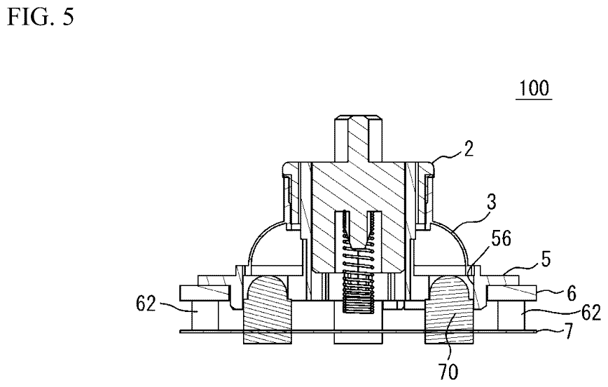

The plate 51 has through holes 56 (third through hole) for disposing light sources such as the LEDs 70. The through holes 56 are formed at positions facing the guide 52 in a radial direction. FIG. 5 is a cross-sectional view of the key switch assembly 100 when the LEDs 70 are disposed in the through holes 56. In FIG. 5, the key top 1 and the support panel 8 are omitted.

When the light sources disposed in the through holes 56 emit light, the light passes through various paths. For example, some light passes through the dome rubber 3. At this time, since the light is diffused by the dome rubber 3, the whole circumference of the key top I can be illuminated, and since the total height of the key switch assembly 100 is not largely changed as described above, the attenuation of the light up to the key top 1 can be suppressed. Further, the variation of the color of the illumination light can be increased by changing only the color of the dome rubber 3 without changing the color of the light source. This can reduce the number of types of LEDs used as the light sources, and thus reduce the number of types of components.

The other part of the light is reflected by the dome rubber 3, passes through the gap between the slider 2 and the guide 52 through the slits 53, and illuminates the key top 1. Further, when the through holes are provided in the grooves 55 as described above, the other part of the light passes through the gap between the slider 2 and the guide 52 through the through holes in the grooves 55 and illuminates the key top 1. In these cases, the light of the light sources can be taken in from the slits 53 or the through holes in the grooves 55, and the amount of light to the key top I can be increased. For example, if the entire key top 1 is transparent, the key top 1 itself appears to emit light, and if the character portion of the key top 1 is transparent, the character portion of the key top 1 appears to emit light.

Referring back to FIG. 4A, projections 57 (a second guide) for fitting the base portion 31 of the dome rubber 3 are provided outside the through holes 56 of the plate 51. A leg portion 59 capable of mounting the housing 5 in an opening 61 of the switch panel 6 is provided on the back surface of the plate 51, and the leg portion 59 is formed with a claw portion 58 for sandwiching the switch panel 6 between the claw portion 58 and the back surface of the plate 51. Since the plate 51 of the housing 5 is square, it can be easily fixed to the square opening 61 of the switch panel 6 even when the plate 51 of the housing 5 is rotated by 90 degrees. Therefore, the degree of freedom in assembling the key switch assembly 100 is increased, and the workability can be improved.

Referring back to FIG. 2A, the membrane switch 7 includes an electrical contact 71. The electrical contact 71 is disposed below the housing 5 and the switch panel 6, and is closed when a predetermined pressing force is applied from the spring 4 by pressing the key top 1. Although the membrane switch 7 is used in the first embodiment, the membrane switch is not particularly limited as long as it is a switch having the electrical contact. For example, a mechanical switch may be employed instead of the membrane switch 7.

The switch panel 6 is disposed on the membrane switch 7 and the support panel 8, and is fixed to the support panel 8 by screws (not illustrated) or the like to spacers 62 provided below the switch panel 6. As illustrated in FIG. 1B, the opening 61 of the switch panel 6 is square in shape, and when the housing 5 is fixed to the opening 61, the opening 61 is covered with the plate 51 of the housing 5. A space 40 having a predetermined height is formed between the switch panel 6, and the membrane switch 7 and the support panel 8 by the spacers 62 (see FIG. 2 a). An area of the plate 51 is larger than an area of the opening 61 of the switch panel 6 in planar view. Therefore, the slider 2, the dome rubber 3, the spring 4 and the housing 5 can be collectively mounted on the switch panel 6 at once without being disassembled by simply inserting the leg portion 59 of the housing 5 into the opening 61 of the switch panel 6.

The slider 2, the dome rubber 3, the spring 4 and the housing 5 are integrated to form the switch unit 101, and the switch unit 101 is fixed to the opening 61 of the switch panel 6 from above by inserting the leg portion 59 of the housing 5 into the opening 61 of the switch panel 6. Thus, the user can easily mount the switch unit 101 having the pressing characteristic of user's preference on the switch panel 6 by simply inserting the leg portion 59 of the housing 5 into the opening 61 of the switch panel 6. The user can replace the switch units 101 mounted on the switch panel 6 for each switch unit.

In the conventional key switch assembly, a slider and a dome rubber having springs mounted thereon are disposed on the front surface side of a switch panel, a housing is disposed on the back surface side of the switch panel, and the switch panel is sandwiched between the slider and the dome rubber and the housing. The slider with the spring attached and the dome rubber must be separately mounted on the switch panel, and the mounting work to the switch panel is complicated. In contrast, the switch unit 101 of the present embodiment can be mounted on the switch panel 6 from above by integrating the slider 2, the dome rubber 3, the spring 4, and the housing 5, and therefore, the mounting work to the switch panel 6 can be easily performed.

In the first embodiment, since the key top 1 is replaceable and the insertion and removal of the key top 1 occurs, the switch unit 101 may be pulled out from the switch panel 6 when the key top 1 is pulled out. For this reason, it is preferable that the leg portion 59 has the claw portion 58 that sandwiches the switch panel 6 between the back surface of the plate 51 and the claw portion 58. As a result, the claw portion 58 comes into contact with the switch panel 6, and the switch unit 101 can be prevented from being pulled out from the switch panel 6 from above.

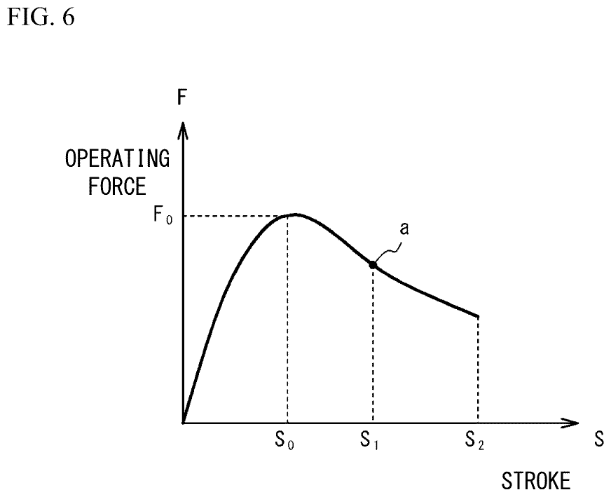

FIG. 6 is a diagram illustrating a depressing characteristic of the key switch assembly 100 according to the first embodiment. A horizontal axis represents a stroke S (an amount of depression) of the key top 1, and a vertical axis represents an operating force F (a depressing force). A point a in FIG. 6 indicates that the contact is ON.

As illustrated in FIG. 6, when the operating force F of the key top 1 increases, the stroke S also increases accordingly. At this time, the dome rubber 3 is elastically deformed, and a reaction force from the dome rubber 3 acts on the key top 1. The depressing characteristic in this case is equal to the load-displacement characteristic of the dome rubber 3 itself, and the operating force F increases until the load acting on the dome rubber 3 reaches the buckling load of the dome rubber 3, and after the buckling load is reached, the operating force F decreases gradually with an increase in the stroke S. By obtaining a peak operating force F0 by the elastic buckling deformation of the dome rubber 3, the user can obtain a click feeling specific to the key pressing operation.

In the first embodiment, the stroke S1 at the contact ON time is set to a value (for example, an intermediate value between strokes S0 and S2) that is larger than the stroke S0 at which the peak operating force F0 is generated and smaller than an end stroke S2. In this way, in the key switch assembly 100, since the spring 4 opens and closes the contact of the membrane switch 7 during the decrease of the operating force F generated when the dome rubber 3 is buckled and deformed, no gap occurs between the operating feeling and the contact ON operation, and a good feeling can be provided to the user.

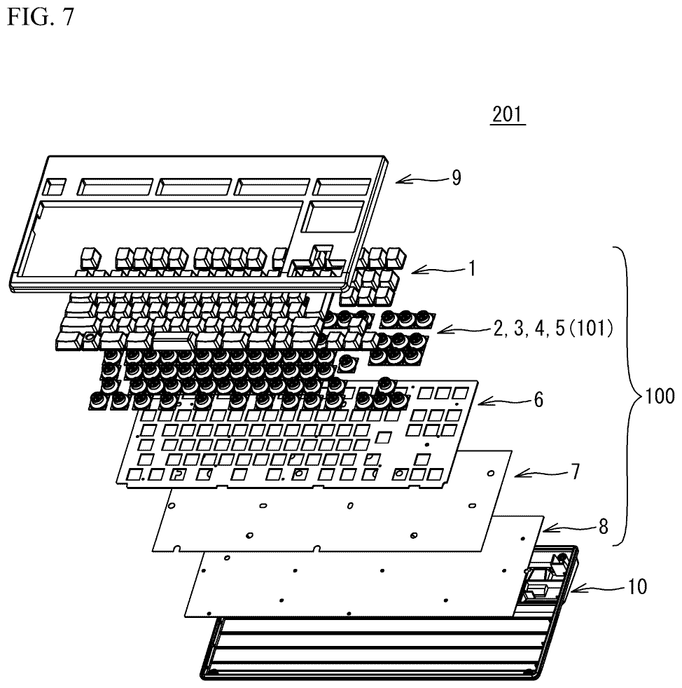

The key switch assembly 100 is provided in, for example, a keyboard. FIG. 7 is a perspective view of a keyboard 201 including a plurality of key switch assemblies 100 according to the first embodiment. The keyboard 201 includes an upper cover 9, a lower cover 10, and the plurality of key switch assemblies 100. In the keyboard 201, the switch panel 6, the membrane switch 7, and the support panel 8 in the key switch assembly 100 are formed so as to be horizontally enlarged over the entire keyboard, and are shared by the respective key switch assemblies 100.

The key switch assembly 100 according to the first embodiment can be applied as an input device such as a ticket vending machine, an ATM, or a kiosk terminal. When the key switch assembly 100 is used alone, the switch panel 6 may not be provided. In this case, the housing 5 may be provided with screw holes, and the housing 5 may be screwed to the support panel 8 through the membrane switch 7.

As described above, according to the first embodiment, in the key switch assembly 100, the slider 2 includes the pedestal 22, the projection 21 provided on the pedestal 22 and capable of attaching the key top 1, and the column 23 provided under the pedestal 22, and the housing 5 includes the plate 51 and the guide 52 vertically standing upward from the center of the plate 51. The pedestal 22 includes the through holes 22a through which the guide 52 of the housing 5 passes, and the guide 52 includes the through hole 54 into which the column 23 of the slider 2 is inserted.

With this configuration, the guide 52 can penetrate the slider 2 through the through hole 22a, and the interference with the couplers 22b of the slider 2 can be avoided by the slits 53 of the guide 52. Therefore, when the slider 2 slides, the projection 21 to which the key top I can be attached can enter the through hole 54 surrounded by the guide 52. Thus, the projection 21 for attaching the key top 1 is provided without greatly changing the total height of the key switch assembly 100, and the pressing force can be transmitted from the key top 1 to the dome rubber 3, whereby the good feeling can be provided to the user.

Further, since the total height of the key switch assembly 100 is not greatly changed, the burden on the wrists of the user is not imposed, and when the light sources are provided at the lower portion of the key switch assembly 100, the distance to the key top 1 is maintained, and therefore, the attenuation of light can be suppressed.

It is conceivable to lower the height of the key switch assembly of Patent Document 1 as a whole and provide a projection for attaching the key top on the slider, but in this case, the key stroke is shortened and the operability is deteriorated. In addition, since it is necessary to reduce the size of the dome rubber, the good feeling cannot be obtained. Furthermore, since the ceiling of the slider is covered, the light is blocked, and the key top cannot be illuminated sufficiently.

In contrast, the key switch assembly 100 of the first embodiment does not adopt a configuration in which the height of the key switch assembly is lowered as a whole and the projection to which the key top can be attached is provided on the slider, and therefore a sufficient key stroke can be secured. Further, since it is not necessary to change the size of the dome rubber 3, the good feeling can be obtained. Further, since the paths for guiding light such as the slit 53 and the gap between the through hole 22a and the guide 52 are formed, the light of the light sources can be guided to the key top 1, and the key top 1 can be illuminated.

### Second Embodiment

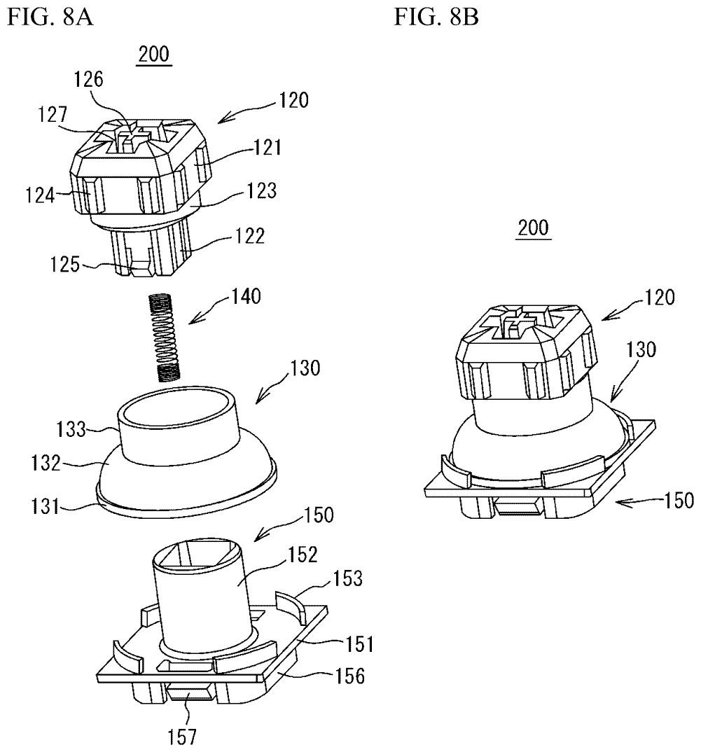

A second embodiment differs from the first embodiment in the structure of the slider and the housing. FIG. 8A is an exploded perspective view illustrating respective parts of a switch unit included in the key switch assembly according to the second embodiment, and FIG. 8B is a perspective view of an integrated switch unit.

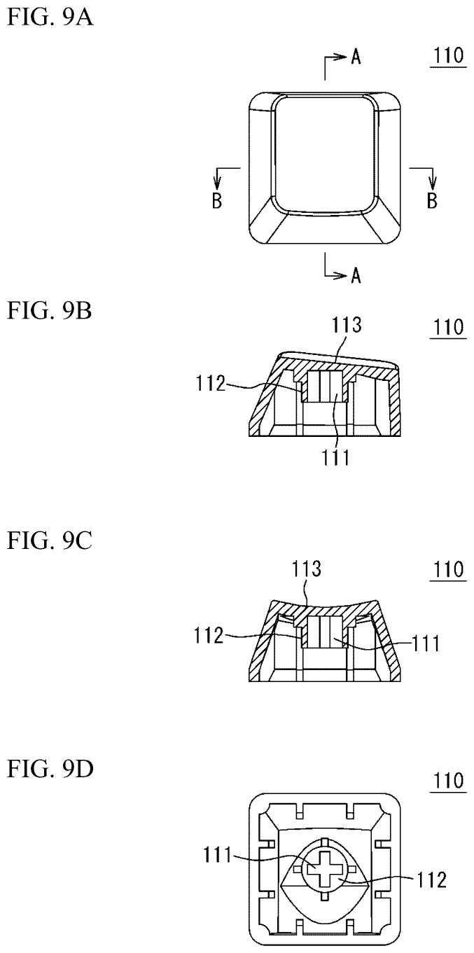

A switch unit 200 illustrated in FIG. 8A includes a slider 120 (a sliding member) to which a key top 110 (see FIGS. 9A to 9D) can be attached and which slides in the vertical direction, a dome rubber 130 (a first elastic member) which is elastically buckled and deformed by pressing operation of the key top 110 and applies a repulsive force corresponding to elastic buckling deformation to the slider 120, a spring 140 (a second clastic member) which is attached to the slider 2 and presses an electrical contact such as a membrane switch or a mechanical switch (not illustrated), and a housing 150 (supporting member) to which the slider 120 is attached and which supports the sliding of the slider 120 in the vertical direction.

In the switch unit 200, the spring 140 is fixed inside a column 122 of the slider 120, and the dome rubber 130 is interposed between the slider 120 and the housing 150, so that the slider 120 is engaged with the housing 150 so that the slider 120 can slide up and down. As a result, the slider 120, the dome rubber 130, the spring 140, and the housing 150 included in the switch unit 200 are integrated as illustrated in FIG. 8B.

The dome rubber 130 is a dome-shaped member integrally molded from a rubber material and has a ring-shaped base portion 131, a dome portion 132 rising in a dome-like manner from the base portion 131, and a cylindrical portion 133 extending upward from the top of the dome portion 132. The cylindrical portion 133 is press-fitted into the outer peripheral surface 123 of the slider 120 from below, and is mounted on the outer peripheral surface 123. The dome portion 132 of the dome rubber 130 is deformed in accordance with the vertical sliding of the slider 120.

FIG. 9A is a plan view illustrating a front side of the key top 110, FIG. 9B is a cross-sectional view taken along a line A-A of FIG. 9A, FIG. 9C is a cross-sectional view taken along a line B-B of FIG. 9A, and FIG. 9D is a plan view illustrating a back side of the key top 110.

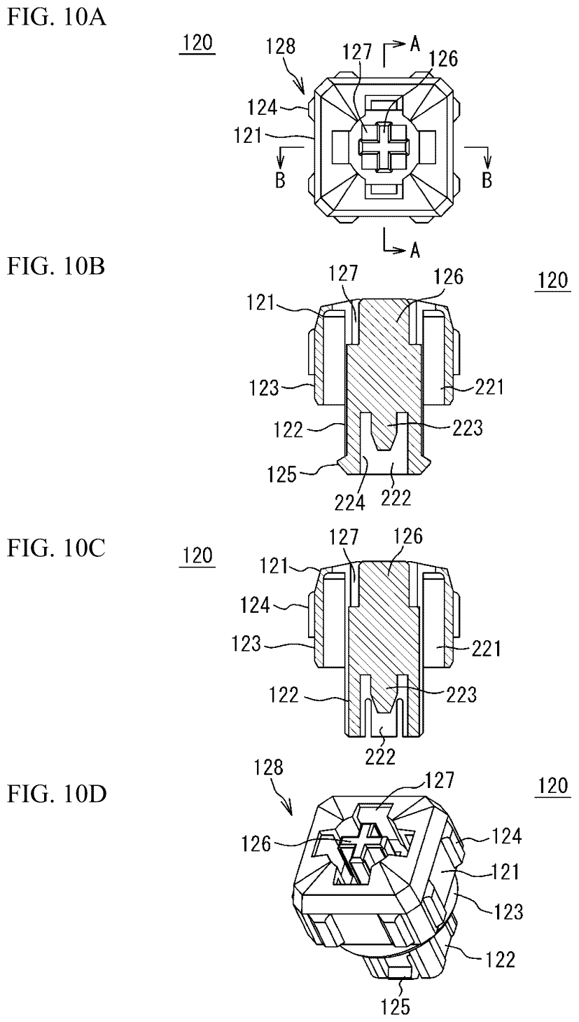

The key top 110 is formed by integral molding using a resin as a constituent material. As illustrated in FIGS. 9B to 9D, a projection 112 projecting downward from an upper surface 113 of the key top 110 is provided on the back surface of the key top 110. The projection 112 is formed with a recess 111 to which the cross-shaped projection 126 of the slider 120 is attached (see FIGS. 8A and 8B and FIGS. 10A to 10D). The structure of the key top 110 is the same as that of the key top 1 of the first embodiment.

FIG. 10A is a plan view of the slider 120 viewed from above, FIG. 10B is a cross-sectional view taken along a line A-A in FIG. 10A, FIG. 10C is a cross-sectional view taken along a line B-B in FIG. 10A, and FIG. 10D is a perspective view of the slider 120.

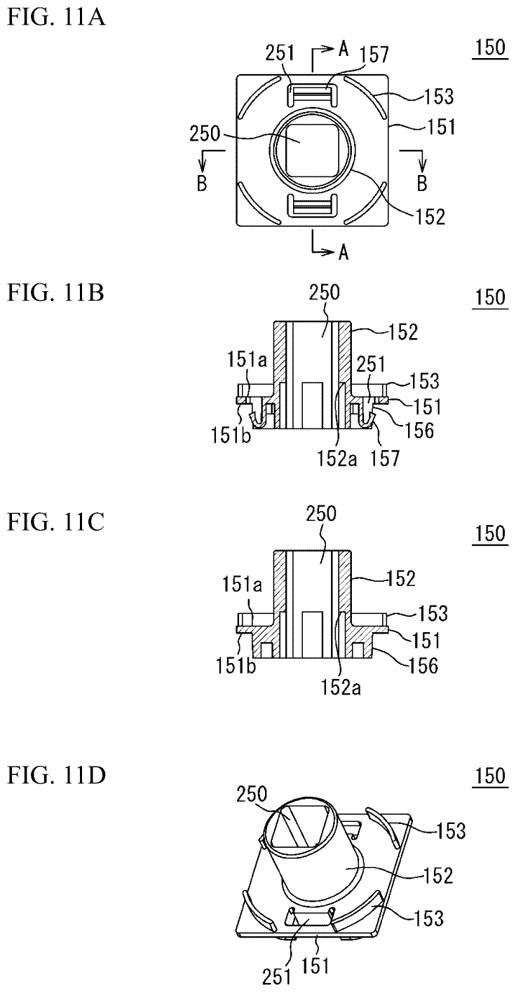

The slider 120 has a main body 121 and the column 122 extending from the main body 121 toward the housing 150. The column 122 in the second embodiment is formed so that the cross-sectional shape thereof is substantially square. The column 122 has a locking claw 125 for slidably locking the slider 120 to the housing 150. The locking claw 125 engages with a step 152a (see FIGS. 11B and 11C) on an inner wall of a guide 152 of the housing 150. The outer periphery of the main body 121 is provided with a projection 124 for engaging with the key top 110 and an outer peripheral surface 123 into which the dome rubber 3 is press-fitted. A space 221 (a first through hole) into which the guide 152 of the housing 150 enters is provided between the main body 121 and the column 122.

A ceiling portion 128, which is the upper end of the slider 120, include a recess 127 (a first recess) for receiving the projection 112 (a second projection) having a cross-shaped recess 111 of the key top 110, and a cross-shaped projection 126 (a first projection) fitted in the cross-shaped recess 111 of the key top 110. The depth of the recess 127 is the same as or greater than the height of the projection 112 of the keytop 110. Thus, even if the cross-shaped projection 126 is provided on the upper end of the slider 120, the total height of the key switch assembly can be suppressed from increasing.

The column 122 has an opening 222 formed in a lower portion thereof, and a projection 223 for fixing the spring 140 is formed in the column 122. A part of the spring 140 is inserted between an inner surface 224 of the column 122 and the projection 223 and fixed thereto.

The slider 120 and the housing 150 are formed of different materials that have less friction when they are in contact with each other. For example, the slider 120 is made of POM resin (polyacetal resin), and the housing 150 is made of ABS resin (thermoplastic resin produced by polymerizing three monomers such as acrylonitrile, butadiene, and styrene). This is because if the slider 120 and the housing 150 are made of the same material, the slider 120 bites into the guide 152 during sliding, and a stack in which the key top 110 does not move occurs. For this reason, the slider 120 and the housing 150 are formed of different materials that have less friction when they are in contact with each other. The material of the slider 120 and the housing 150 is not limited to resin. The slider 120 and the housing 150 may be processed to have a small friction coefficient at the contact portion thereof so that the friction is reduced at the time of contact.

FIG. 11A is a plan view of the housing 150 viewed from above, FIG. 11B is a cross-sectional view taken along a line A-A in FIG. 11A, FIG. 11C is a cross-sectional view taken along a line B-B in FIG. 11A, and FIG. 11D is a perspective view of the housing 150.

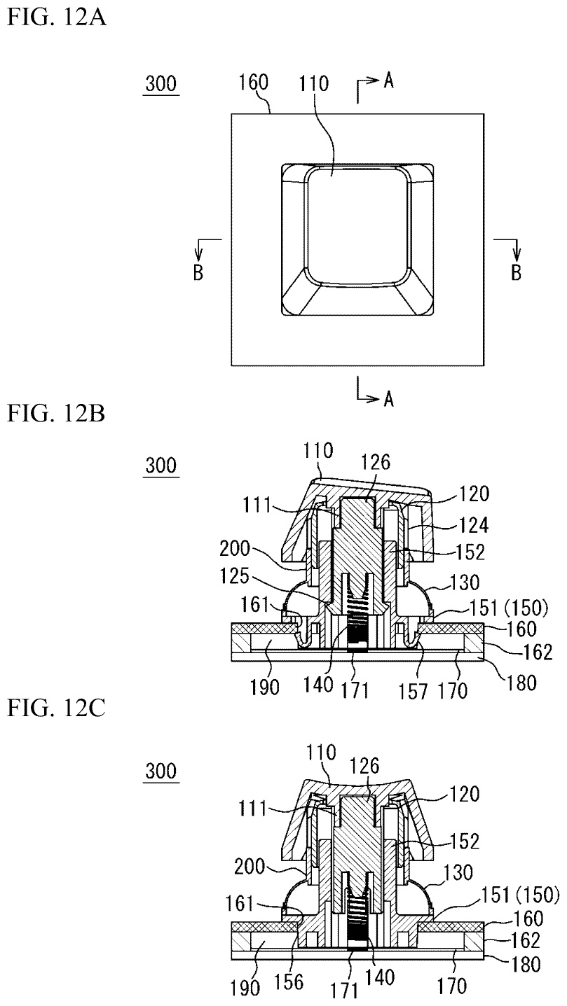

The housing 150 is a member for supporting the slider 120 and the dome rubber 130, and includes a square plate 151 constituting a base substrate. The housing 150 includes: the guide 152 (first guide) that stands upward from the center of a front surface 151a of the plate 151 and guides the dome rubber 130; a projecting portion 153 (second guide) that is provided on the front surface 151a of the plate 151, guides the dome rubber 130, and is provided outside the guide 152 when the plate 151 is viewed from above; and leg portions 156 that are provided on a back surface 151b of the plate 151 and are attachable to an opening 161 (see FIGS. 12B and 12C) of a switch panel 160 (a member to be attached). The leg portion 156 has a claw portion 157 that sandwiches the switch panel 160 between the back surface 151b of the plate 151 and the claw portion 157. When only the leg portion 156 may be sufficient to fix the switch panel 160, the leg portion 156 may not necessarily include the claw portion 157. An opening 251 is formed at a position of the plate 151 above the claw portion 157. This allows the user to confirm from above whether the switch panel 160 is sandwiched between the claw portion 157 and the back surface 151b of the plate 151. The number of the claw portions 157 is not limited to two, but may be four.

A through hole 250 (a second through hole) having a substantially rectangular cross section for inserting the column 122 of the slider 120 is opened in the center of the guide 152.

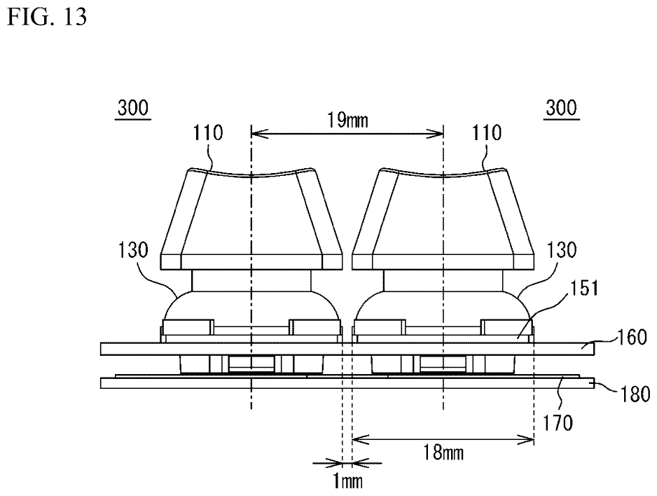

FIG. 12A is a plan view of the key switch assembly according to the second embodiment as viewed from above, FIG. 12B is a cross-sectional view taken along a line A-A in FIG. 12A, and FIG. 12C is a cross-sectional view taken along a line B-B in FIG. 12A. FIG. 13 is a diagram illustrating an example in which a plurality of key switch assemblies are arranged.

A key switch assembly 300 according to the second embodiment includes: the switch unit 200 including the slider 120, the dome rubber 130, the spring 140, and the housing 150; the key top 110 that is attached to the switch unit 200 and pressed downward; the switch panel 160 that is a positioning member for determining the position of the housing 150; a membrane switch 170 that is arranged under the housing 150 and the switch panel 160 and includes an electrical contact; and a support panel 180 that is arranged under the membrane switch 170 and fixes the switch panel 160.

The membrane switch 170 includes an electrical contact 171. The electrical contact 171 are disposed below the housing 150 and the switch panel 160 and are closed when a predetermined pressing force is applied from the spring 140 by pressing the key top 110. In the second embodiment, the membrane switch 170 is used, but the membrane switch is not particularly limited as long as it is a switch having the electrical contact. For example, a mechanical switch may be employed instead of the membrane switch 170.

The switch panel 160 is disposed on the membrane switch 170 and the support panel 180, and is fixed to the support panel 180 by screws (not illustrated) or the like to spacers 162 provided below the switch panel 160. The opening 161 of the switch panel 160 is square in shape in planar view, and when the leg portion 156 of the housing 150 is mounted in the opening 161, the opening 161 is covered with the plate 151 of the housing 150. A space 190 having a predetermined height is formed by the spacers 162 between the switch panel 160, and the membrane switch 170 and the support panel 180.

If the predetermined space 190 is formed at the height of the leg portion 156, the lower portion of the housing 150 is adhered to the upper surface of the membrane switch 170 with a double-sided tape or the like, whereby the key switch assembly 300 can be configured without providing the switch panel 160.

When the user depresses the key top 110, the column 122 of the slider 120 slides with respect to the through hole 250 of the guide 152, whereby the slider 120 moves downward. The dome rubber 130 is deformed outward by the movement of the slider 120. The spring 140 attached to the slider 120 comes into contact with the membrane switch 170 by the movement of the slider 120, and the spring 140 compresses to press the membrane switch 170, causing the electrical contact 171 to be turned on.

When the user releases a user's finger from the key top 110, the slider 120 returns to its original position due to the elastic force of the dome rubber 130 and the spring 140. In the membrane switch 170, the pressing force of the key top 110 is reduced, and the electrical contact 171 is opened. The depressing characteristic of the key switch assembly 300 is similar to that of the key switch assembly 100 illustrated in FIG. 6.

The key switch assembly 300 is provided in, for example, the keyboard. The plurality of key switch assemblies 100 of FIG. 7 may be replaced with a plurality of key switch assemblies 300 to create the keyboard 201.

In the switch unit 200, an area of the plate 151 is larger than an area of the opening 161 of the switch panel 160 in planar view. Therefore, the plate 151 of the housing 150 comes into contact with a peripheral portion of the opening 161 of the switch panel 160, and the leg portion 156 of the housing 150 can be mounted in the opening 161 of the switch panel 160. The entire housing 150 can be prevented from sinking into the opening 161 of the switch panel 160.

If the diameter of the base portion 131 of the dome rubber 130 is larger than the length of one side of the plate 151 of the housing 150, the base portion 131 of the dome rubber 130 protrudes from the plate 151 of the housing 150, and therefore it becomes difficult to obtain the depressing characteristic of the key switch assembly illustrated in FIG. 6. When the diameter of the base portion 131 of the dome rubber 130 is smaller than 70% of the length of one side of the plate 151 of the housing 150, the size of the dome rubber 130 is reduced, and it becomes difficult to obtain the depressing characteristic of the key switch assembly illustrated in FIG. 6. For this reason, it is preferable that the diameter of the base portion 131 of the dome rubber 130 is 70% or more and 100% or less of the length of one side of the plate 151 of the housing 150. In particular, by setting the diameter of the base portion 131 of the dome rubber 130 and the length of one side of the plate 151 of the housing 150 to the same length, the size of the dome rubber 130 is increased, so that the depressing characteristic of the key switch assembly of FIG. 6 can be easily obtained, and the housing 150 can hold the dome rubber 130.

In the conventional key switch assemblies, since the housing is inserted from under the support panel, a flange for preventing the housing from coming off is required, and the lower portion of the housing disposed under the support panel becomes large. For this reason, as illustrated in FIG. 13, it is difficult to set a distance between the centers of two adjacent key tops 110 to 19 mm by using the dome rubber 130 having a diameter of 18 mm.

In the second embodiment, as illustrated in FIG. 13, when the distance between the centers of two adjacent key tops 110 is 19 mm and the opening 161 is set to a square of 15 to 16 mm, for example, the plate 151 of the housing 150 can be set to a square of 18 mm and the diameter of the base portion 131 of the dome rubber 130 can be set to 18 mm. The distance between the plates 151 of the two adjacent housings 150 can be set to 1 mm. The sizes of the opening 161, the plate 151, and the dome rubber 130 are examples, and the sizes of the opening 161, the plate 151, and the dome rubber 130 can be adjusted as long as the adjacent keys do not interfere with each other.

As described above, according to the second embodiment, the switch unit 200 includes: the slider 120 to which the key top 110 is attachable and which is slidable by the pressing operation of the key top 110; the dome rubber 130 that is attached to the slider 120 and elastically deforms in response to the pressing operation of the key top 110; the spring 140 that is attached to the slider 120 and opens and closes the electrical contact 171 in response to the sliding of the slider 120; and the housing 150 including: the plate 151 having the front surface 151a and the back surface 151b; the guide 152 that stands on the front surface 151a and guides the slider 120; the projecting portion 153 that stands on the front surface 151a, guides the dome rubber 130, and is provided outside the guide 152 when the plate 151 is viewed from above; and the leg portion 156 that stands on the back surface 151b and is attachable to the opening 161 of the switch panel 160. In planar view, the area of the plate 151 is larger than the area of the opening 161 of the switch panel 160. Therefore, the slider 120, the dome rubber 130, the spring 140, and the housing 150 can be collectively mounted on the switch panel 160 at once without being disassembled by simply inserting the leg portion 156 of the housing 150 into the opening 161 of the switch panel 160.

The slider 120, the dome rubber 130, the spring 140, and the housing 150 are integrated to form the switch unit 200, and the switch unit 200 is fixed to the opening 161 of the switch panel 160 from above by inserting the leg portion 156 of the housing 150 into the opening of the switch panel 160. Thus, the user can easily mount the switch unit 200 having the pressing characteristic of user's preference to the switch panel 160 by simply inserting the leg portion 156 of the housing 150 into the opening 161 of the switch panel 160. The user can replace the switch units 200 mounted on the switch panel 160 for each switch unit.

In the conventional key switch assembly, a slider and a dome rubber having springs mounted thereon are disposed on the front surface side of a switch panel, a housing is disposed on the back surface side of the switch panel, and the switch panel is sandwiched between the slider and the dome rubber and the housing. The slider with the spring attached and the dome rubber must be separately mounted on the switch panel, and the mounting work to the switch panel is complicated. In contrast, the switch unit 200 of the present embodiment can be mounted on the switch panel 160 from above by integrating the slider 120, the dome rubber 130, the spring 140, and the housing 150, and therefore, the mounting work to the switch panel 160 can be easily performed.

In the second embodiment, since the key top 110 is replaceable and the insertion and removal of the key top 110 occurs, the switch unit 200 may be pulled out from the switch panel 160 when the key top 110 is pulled out. For this reason, it is preferable that the leg portion 156 has the claw portion 157 that sandwiches the switch panel 160 between the back surface 151b of the plate 151 and the claw portion 157. Ac a result, the claw portion 157 comes into contact with the switch panel 160, and the switch unit 200 can be prevented from being pulled out from the switch panel 160 from above.

Since the ceiling portion 128, which is the upper end of the slider 120, includes the recess 127 for receiving the projection 112 having the recess 111 of the key top 110, and the projection 126 fitted in the recess 111 of the key top 110, the total height of the key switch assembly 300 can be suppressed from being increased even if the projection 126 is provided on the upper end of the slider 120.

All examples and conditional language provided herein are intended for the purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A switch unit comprising:
a sliding member to which an operating member is attachable and which is slidable by pressing operation of the operating member; and
a supporting member that supports the sliding member,
wherein an electrical contact is opened and closed in accordance with sliding movement of the sliding member,
the sliding member includes a pedestal, a first projection provided on a pressing operation side from the pedestal along a sliding direction of the sliding member and capable of attaching the operating member, and a column provided on a side opposite to the pressing operation side from the pedestal along the sliding direction,
the supporting member includes a plate and a first guide provided from the plate to the pressing operation side along the sliding direction,
the pedestal has a first through hole through which the first guide passes, and
the first guide has a second through hole into which the column is inserted.

2. The switch unit according to claim 1, wherein
when the operating member is pressed and positioned at a lowermost position, an upper end of the sliding member is at substantially the same height as an upper end of the first guide or is positioned below the upper end of the first guide.

3. The switch unit according to claim 1, further comprising:
a first elastic member that is attached to the sliding member and elastically deforms in response to the pressing operation of the operating member; and
a second elastic member that is attached to the sliding member and opens and closes an electrical contact in response to sliding of the sliding member.

4. The switch unit according to claim 1, wherein
the pedestal has a cylindrical shape and includes a coupler for coupling a side surface of the pedestal and the column,
the first guide includes a slit for avoiding interference with the coupler, and
a length of the slit in the sliding direction is substantially equal to a thickness of the column in the sliding direction.

5. The switch unit according to claim 1, wherein
an extension portion extending along the column is formed in a part of an outer periphery of a lower surface of the pedestal,
a second projection projecting radially inward is formed at a lower portion of the extension portion, and
the first guide of the supporting member has a groove formed therein, the groove being engaged with the second projection and extending in the sliding direction.

6. The switch unit according to claim 5, wherein
a length of the extension portion in the sliding direction is set such that, when the operating member is not pressed, a position of an upper surface of the pedestal is substantially the same as a position of an upper end of the first guide in a state where the second projection is engaged with the groove.

7. The switch unit according to claim 1, wherein
the plate includes a third through hole for disposing a light source.

8. A key switch assembly that opens and closes an electrical contact by pressing operation of an operating member, the key switch assembly comprising:
the switch unit according to claim 1;
the operating member attached to the switch unit; and
the electrical contact disposed under the switch unit.

9. A keyboard comprising a plurality of key switch assemblies according to claim 8.

10. A switch unit comprising:
a sliding member to which an operating member is attachable and which is slidable by pressing operation of the operating member;
a first elastic member that is attached to the sliding member and elastically deforms in response to the pressing operation of the operating member;
a second elastic member that is attached to the sliding member and opens and closes an electrical contact in response to sliding of the sliding member; and
a supporting member including:
a plate having a first surface and a second surface opposite to the first surface;
a first guide that stands on the first surface of the plate and guides the sliding member;
a second guide that stands on the first surface of the plate, guides the first elastic member, and is provided outside the first guide when the plate is viewed from above; and
a leg portion that stands on the second surface of the plate.

11. The switch unit according to claim 10, wherein
the leg portion includes a claw portion for fixing the leg portion to a member to be mounted.

12. The switch unit according to claim 10, wherein
the sliding member includes a pedestal, a first projection provided on a pressing operation side from the pedestal along a sliding direction of the sliding member and capable of attaching the operating member, and a column provided on a side opposite to the pressing operation side from the pedestal along the sliding direction,
the pedestal has a first through hole through which the first guide passes, and
the first guide has a second through hole into which the column is inserted.

13. The switch unit according to claim 10, wherein
a ceiling portion of the sliding member includes a first projection to which the operating member is attachable, and a first recess that receives a second projection provided on the operating member.

14. A key switch assembly that opens and closes an electrical contact by pressing operation of an operating member, the key switch assembly comprising:
the switch unit according to claim 10;
the operating member attached to the switch unit;
a member to be mounted having an opening for mounting the leg portion of the switch unit; and
the electrical contact disposed under the switch unit.

15. A key switch assembly that opens and closes an electrical contact by pressing operation of an operating member, the key switch assembly comprising:
the switch unit according to claim 10;
the operating member attached to the switch unit; and
a membrane switch having the electrical contact,
wherein the supporting member is adhered to the membrane switch.

16. A keyboard comprising a plurality of key switch assemblies according to claim 14.

17. A keyboard comprising a plurality of key switch assemblies according to claim 15.
